(19) United States
(12) Patent Application Publication
(10) Pub. No.: US 2026/0167568 A1
(43) Pub. Date: Jun. 18, 2026

(54) Reflective Granular Compositions

(71) Applicant: U.S. Silica Company, Katy, TX (US)

(72) Inventors: Ramanan Pitchumani, Hagerstown, MD (US); Rocky Lee Smith, Needmore, PA (US); William Richard Wells, Hancock, MD (US); James Alan Brady, Berkeley Springs, WV (US); David Earl Weller, JR., Greencastle, PA (US)

(21) Appl. No.: 19/119,794

(22) PCT Filed: Oct. 11, 2023
(86) PCT No.: PCT/US23/34897

§ 371 Date: Apr. 10, 2025

Related U.S. Application Data
(60) Provisional application No. 63/415,075, filed on Oct. 11, 2022.

(51) Int. Cl. C04B 14/24; C09D 7/62; C09D 11/38

(52) U.S. Cl. CPC C04B 14/24; C09D 7/62; C09D 11/38

(57) ABSTRACT

The present disclosure is directed to a reflective granular composition including: a reflective pigment material including kaolin clay; aluminum trihydrate (ATH); and a hardening additive. The present disclosure is also directed to an architectural material including the reflective granular composition. The present disclosure is also directed to a method of making the reflective granular composition.

### CROSS-REFERENCE TO RELATED APPLICATIONS

This application is the United States national phase of International Application No. PCT/US23/34897 filed Oct. 11, 2023, and claims the benefit of priority to U.S. Provisional Patent Application No. 63/415,075, filed Oct. 11, 2022, the disclosures of which are hereby incorporated by reference in their entireties.

### BACKGROUND

### Field

The present disclosure relates to reflective granular compositions and methods for making the same.

### Technical Considerations

Commercial and residential roofs are continuously exposed to the outside elements, which are often harsh or extreme. Even under moderate external conditions, these roofs are exposed to environmental or weather conditions that affect the ability of the roofs to insulate the building or residence interiors from the effects of the environmental or weather conditions. In many parts of the world, during the summer months, roofs are continuously exposed to high heat and sunny conditions under which the roofing materials absorb solar energy and retain high levels of heat. As the roofs absorb the solar energy and retain heat, the conditions inside the underlying buildings or residences suffer adversely, which often causes the interiors to heat up to uncomfortable conditions.

In order to remedy these conditions, the buildings or residences often resort to increased amounts of internal insulation, or increased use of artificial cooling systems (e.g., HVAC equipment). However, increasing the amount of insulation has a limited ability to reduce heat transfer, and increasing energy costs make the increased use of artificial cooling systems undesirable or even cost-prohibitive.

Accordingly, it would be desirable to provide roofs more resistant to temperature increases induced by incident solar radiation.

### SUMMARY

The present disclosure relates to a reflective granular composition including: a reflective pigment material including kaolin clay; aluminum trihydrate (ATH); and a hardening additive.

In some non-limiting embodiments or aspects, the reflective granular composition may include at least 50% by weight of the kaolin clay, based on total solids of the reflective granular composition. The reflective pigment material may include a secondary pigment component selected from the group consisting of: metal and transition metal oxides, alkaline earth metal sulfates, alkaline earth metal carbonates, transition metal silicates, metal silicates, minerals, and mixtures thereof. The reflective pigment material may consist of the kaolin clay. The reflective granular composition may include from 5 to 40% by weight of the ATH, based on total solids of the reflective granular composition. The hardening additive may include a sodium salt or another salt. The reflective granular composition may include from 1% to 15% by weight of the sodium salt, based on total solids of the reflective granular composition. The reflective granular composition may include from 3% to 12% by weight of the sodium salt, based on total solids of the reflective granular composition. The sodium salt may be selected from the group consisting of: sodium silicate, sodium hydroxide, sodium carbonate, sodium chloride, sodium polyacrylate, sodium sulfate, sodium thiosulfate, sodium phosphate, and mixtures thereof, or the other salt may be selected from the group consisting of: any of the foregoing salts of barium, potassium, calcium, and lithium. The reflective granular composition may include an effective amount of the kaolin clay and the ATH so as to exhibit a total solar reflectance of at least 70%.

The present disclosure also relates to an architectural material including the reflective granular composition described herein.

In some non-limiting embodiments or aspects, the architectural material may include a roofing material.

The present disclosure also relates to a method for making a reflective granular composition, including: mixing together a reflective pigment material including kaolin clay; aluminum trihydrate (ATH); and a hardening additive to form a particulate mixture; forming a slurry from the particulate mixture by adding to the particulate mixture water and a binder material; granulating and/or drying the slurry; and kilning the granulated and/or dried slurry to form the reflective granular composition.

In some non-limiting embodiments or aspects, the reflective pigment material may include a secondary pigment component selected from the group consisting of: metal and transition metal oxides, alkaline earth metal sulfates, alkaline earth metal carbonates, transition metal silicates, metal silicates, minerals, and mixtures thereof. The reflective pigment material may consist of the kaolin clay. The hardening additive may include a sodium salt or another salt. The sodium salt may be selected from the group consisting of: sodium silicate, sodium hydroxide, sodium carbonate, sodium chloride, sodium polyacrylate, sodium sulfate, sodium thiosulfate, sodium phosphate, and mixtures thereof, or the other salt may be selected from the group consisting of: any of the foregoing salts of barium, potassium, calcium, and lithium. The water may be added in an amount of from 20% to 50% by weight, based on total weight of the slurry. The binder material may be added in an amount of from 1% to 10% by weight, based on dry weight of kaolin clay. Granulating the slurry may include extruding the slurry or spraying the slurry. The method may further include crushing the dried, granulated slurry prior to kilning the dried, granulated slurry. Kilning may be performed at a temperature of from 900° C. to 1500° C.

The present disclosure also includes the following clauses.

Clause 1: A reflective granular composition comprising: a reflective pigment material comprising kaolin clay; aluminum trihydrate (ATH); and a hardening additive.

Clause 2: The reflective granular composition of clause 1, wherein the reflective granular composition comprises at least 50% by weight of the kaolin clay, based on total solids of the reflective granular composition.

Clause 3: The reflective granular composition of clause 1 or 2, wherein the reflective pigment material comprises a secondary pigment component selected from the group consisting of: metal and transition metal oxides, alkaline earth metal sulfates, alkaline earth metal carbonates, transition metal silicates, metal silicates, minerals, and mixtures thereof.

Clause 4: The reflective granular composition of any of clauses 1-3, wherein the reflective pigment material consists of the kaolin clay.

Clause 5: The reflective granular composition of any of clauses 1-4, wherein the reflective granular composition comprises from 5 to 40% by weight, such as from 15 to 25% by weight, of the ATH, based on total solids of the reflective granular composition.

Clause 6: The reflective granular composition of any of clauses 1-5, wherein the hardening additive comprises a sodium salt or another salt.

Clause 7: The reflective granular composition of clause 6, wherein the reflective granular composition comprises from 1% to 15% by weight of the sodium salt, based on total solids of the reflective granular composition.

Clause 8: The reflective granular composition of clause 6 or 7, wherein the reflective granular composition comprises from 3% to 12% by weight of the sodium salt, based on total solids of the reflective granular composition.

Clause 9: The reflective granular composition of any of clauses 6-8, wherein the sodium salt is selected from the group consisting of: sodium silicate, sodium hydroxide, sodium carbonate, sodium chloride, sodium polyacrylate, sodium sulfate, sodium thiosulfate, sodium phosphate, and mixtures thereof; or wherein the other salt is selected from the group consisting of: any of the foregoing salts of barium, potassium, calcium, and lithium.

Clause 10: The reflective granular composition of any of clauses 1-9 comprising an effective amount of the kaolin clay and the ATH so as to exhibit a total solar reflectance of at least 70%.

Clause 11: An architectural material comprising the reflective granular composition of any of clauses 1-10.

Clause 12: The architectural material of clause 11, wherein the architectural material comprises a roofing material.

Clause 13: A method for making a reflective granular composition, such as the reflective granular composition of any of clauses 1-10, comprising: mixing together a reflective pigment material comprising kaolin clay; aluminum trihydrate (ATH); and a hardening additive to form a particulate mixture; forming a slurry from the particulate mixture by adding to the particulate mixture water and a binder material; granulating and/or drying the slurry; and kilning the granulated and/or dried slurry to form the reflective granular composition.

Clause 14: The method of clause 13, wherein the reflective pigment material comprises a secondary pigment component selected from the group consisting of: metal and transition metal oxides, alkaline earth metal sulfates, alkaline earth metal carbonates, transition metal silicates, metal silicates, minerals, and mixtures thereof.

Clause 15: The method of clause 13 or 14, wherein the reflective pigment material consists of the kaolin clay.

Clause 16: The method of any of clauses 13-15, wherein the hardening additive comprises a sodium salt or another salt.

Clause 17: The method of clause 16, wherein the sodium salt is selected from the group consisting of: sodium silicate, sodium hydroxide, sodium carbonate, sodium chloride, sodium polyacrylate, sodium sulfate, sodium thiosulfate, sodium phosphate, and mixtures thereof; or wherein the other salt is selected from the group consisting of: any of the foregoing salts of barium, potassium, calcium, and lithium.

Clause 18: The method of any of clauses 13-17, wherein the water is added in an amount of from 20% to 50% by weight, based on total weight of the slurry.

Clause 19: The method of any of clauses 13-18, wherein the binder material is added in an amount of from 1% to 10% by weight, based on dry weight of kaolin clay.

Clause 20: The method of any of clauses 13-19, wherein granulating the slurry comprises extruding the slurry or spraying the slurry.

Clause 21: The method of any of clauses 13-20, further comprising crushing the dried, granulated slurry prior to kilning the dried, granulated slurry.

Clause 22: The method of any of clauses 13-21, wherein kilning is performed at a temperature of from 900° C. to 1500° C.

### DETAILED DESCRIPTION

For purposes of the following detailed description, it is understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in its respective testing measurement.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

As used herein, the term “granular roofing material,” “particulate roofing material,” and like terms, refer to solar reflective particulates or granules that are useful in so-called “cool roof” applications, and these terms are used interchangeably with the terms “solar reflective particulates,” “solar reflective granules,” “reflective particulates,” “reflective granules,” and like terms. Additionally, while the particulates and granules described herein are described in terms of their efficacy in “cool roof” applications, it is understood that the described particulates and granules may have other uses and applications, and that the described embodiments are not limited to use in “cool roof” applications. For example, in some non-limiting embodiments, the particulate roofing materials described herein may be useful on any exterior surface, for example, as a filler in an exterior paint, or like application.

A reflective granular composition comprises: a reflective pigment material comprising kaolin clay; aluminum trihydrate (ATH); and a hardening additive. The reflective pigment material and ATH and hardening additive may be solid and/or particulate components.

A method for making a reflective granular composition comprises: mixing together a reflective pigment material comprising kaolin clay; aluminum trihydrate (ATH); and a hardening additive to form a particulate mixture; forming a slurry from the particulate mixture by adding to the particulate mixture water and a binder material; granulating and/or drying the slurry; and kilning the granulated and/or dried slurry to form the reflective granular composition.

The particulate mixture of the reflective granular compositions of the present disclosure may include a reflective pigment material, which includes kaolin clay, but may also include some amount of other reflective pigments. As used herein, the term “clay-based pigment compositions” refers to pigment compositions that include clay (e.g., hydrous or calcined kaolin clay) as the primary component (i.e., clay is present in the pigment composition in the largest quantity over any other component).

The reflective pigment material may comprise kaolin clay. The kaolin clay may comprise at least 50% by weight, such as at least 60%, at least 70%, at least 80%, at least 90%, or 94% of the reflective granular composition, based on total solids thereof. The kaolin clay may comprise from 50% to 94% by weight, such as from 50% to 80%, from 50% to 75%, or from 50% to 60% of the reflective granular composition, based on total solids thereof.

The type or source of the kaolin clay used in the reflective pigment material is not particularly limited in the present disclosure. Non-limiting examples of kaolin clay materials include EPK kaolin (e.g., having an Fe content of about 0.93 wt %, where the reported Fe content is adjusted to exclude loss-on-ignition (LOI) and normalized to a total oxide content of 100%) available from Edgar Minerals (Edgar, FL), MCNAMEE kaolin (e.g., having an Fe content of about 0.38 wt %, where the reported Fe content is adjusted to exclude LOI and normalized to a total oxide content of 100%) available from Vanderbilt Minerals, LLC (Norwalk, CT), Kingsley kaolin (e.g., having an Fe content of about 0.45 wt %, where the reported Fe content is adjusted to exclude LOI and normalized to a total oxide content of 100%) available from Kentucky-Tennessee Clay Company (Roswell, GA), 6 TILE kaolin (e.g., having an Fe content of about 0.4 wt %, where the reported Fe content is adjusted to exclude LOI and normalized to a total oxide content of 100%) available from Kentucky-Tennessee Clay Company (Roswell, GA), optiKasT kaolin (e.g., having an Fe content of about 0.58 wt %, where the reported Fe content is adjusted to exclude LOI and normalized to a total oxide content of 100%) available from Kentucky-Tennessee Clay Company (Roswell, GA), lone Airfloated Kaolin (e.g., having an Fe content of about 0.7 wt %, where the reported Fe content is adjusted to exclude LOI and normalized to a total oxide content of 100%) available from lone Minerals, Inc. (lone, CA), kaolin-containing products available from Thiele Kaolin Company (Sandersville, GA), and kaolin-containing products available from Imerys S.A. (Paris, France). The kaolin clay may comprise calcined kaolin clay.

The kaolin clay in the reflective granular composition may function as a reflective pigment which is highly reflective at certain wavelengths of solar radiation which reach the Earth's surface. When the reflective granular composition is arranged at a surface of an object positioned in outdoor conditions, the kaolin clay may reflect at least a portion of the solar radiation incident to the object to reduce the rise in temperature of the object caused by the incident solar radiation (by the object absorbing less and reflecting more solar radiation compared to the same object coated with the same composition not containing the kaolin clay).

In some non-limiting embodiments, the reflective pigment material may also include at least one secondary pigment component (different from the kaolin or ATH or hardening additive). For example, the secondary pigment components may include additional pigment materials, and/or pigment additives. Some non-limiting examples of suitable secondary pigment components include metal and transition metal oxides (e.g., TiO₂, ZnO, SnO, and various titanates), alkaline earth metal sulfates (e.g., BaSO₄, MgSO₄ (including anhydrous or hydrated forms, such as, e.g., Epsom salt) and the like), alkaline earth metal carbonates (e.g., SrCO₃ and BaCO₃), transition metal silicates (e.g., ZrSiO₄), metal silicates (e.g., alkaline earth metal silicates and alkali metal silicates, non-limiting examples of which include Ca₂SiO₄, Ba₂SiO₄, magnesium silicate, and ZrSiO₄) and minerals (e.g., cristobalite). For example, in some non-limiting embodiments, the secondary pigment component may include TiO₂, BaSO₄, ZnO, ZrSiO₄, SrCO₃, a metal silicate (e.g., an alkali metal silicate and/or an alkaline earth metal silicate), and/or cristobalite.

The particulate mixture of the reflective granular compositions of the present disclosure may include aluminum trihydrate (ATH). Non-limiting examples of suitable ATH that may be used include POYLFILL or POLYJET products available from Cimbar Performance Materials (Chatsworth, GA), such as POLYFILL 30, POLYFILL 110, POLYFILL 130, POLYFILL 203, POLYFILL 204, POLYFILL 301, POLYFILL 302, POLYFILL 402, POLYFILL 403, POLYFILL 405, POLYFILL 407, and POLYJET 502.

The reflective granular composition may comprise from 5 to 40% by weight of the ATH, such as from 20% to 40% by weight, 10% to 30% by weight, from 15% to 25% by weight, or from 20% to 25% by weight, based on total solids of the reflective granular composition. The reflective granular composition may comprise at least 5% by weight of the ATH, such as at least 10%, at least 15%, at least 20%, at least 25%, or at least 30%, based on total solids of the reflective granular composition. The reflective granular composition may comprise up to 40% by weight of the ATH, such as up to 35%, up to 30%, up to 25%, or up to 20%, based on total solids of the reflective granular composition.

The ATH in the reflective granular composition may function as an additional highly solar reflective component, in addition to the kaolin clay. The ATH may be highly reflective at certain wavelengths of solar radiation which reach the Earth's surface. The ATH may be reflective at the same or different wavelengths of solar radiation compared to the kaolin clay. ATH may be particularly effective at reflecting certain ultraviolet (UV) wavelengths of solar radiation compared to the kaolin clay. When the reflective granular composition is arranged at a surface of an object positioned in outdoor conditions, the ATH may reflect at least a portion of the solar radiation incident to the object to reduce the rise in temperature of the object caused by the incident solar radiation (by the object absorbing less and reflecting more solar radiation compared to the same object coated with the same composition not containing the ATH).

The reflective granular composition comprising both kaolin clay and ATH may be more effective at reflecting solar radiation (e.g., measured by total solar reflectance) compared to the same composition except omitting either the kaolin clay or the ATH.

The reflective granular composition may comprise an effective amount of the kaolin clay and the ATH so as to exhibit a bulk total solar reflectance (also referred to herein as “total solar reflectance” (TSR) or simply “solar reflectance”) of at least 70%, such as at least 80% or at least 85%, as measured using a reflectometer from Surface Optics Corporation (San Diego, CA). The reflective granular composition may exhibit a TSR of from 70-90%, from 80-90%, from 70-95%, or from 80-95%. For example, the 410-Solar visible/NIR Portable Reflectometer from Surface Optics Corporation (San Diego, CA) may be used, which measures reflectance over 7 wavelength bands and uses an algorithm to calculate the TSR.

The reflective granular composition may comprise an effective amount of the kaolin clay and the ATH so as to exhibit a UV reflectance (e.g., in the 335-380 nm wavelength band) of at least 20%, such as from 20% to 80%. In some non-limiting embodiments, the reflective granular composition may exhibit a UV reflectance of at least 25%, such as from 25% to 75%, from 25% to 70%, or from 40% to 70%, as measured using a solar reflectometer from Surface Optics Corporation (San Diego, CA). For example, in some non-limiting embodiments, the reflective granular composition may exhibit a UV reflectance of at least 50%, such as from 50% to 70%, as measured using a solar reflectometer from Surface Optics Corporation (San Diego, CA).

The reflective granular composition may comprise an effective amount of the kaolin clay and the ATH so as to exhibit a visible light (“VIS”) reflectance (e.g., in the 400-720 nm wavelength band) of at least 60%, for example from 60% to 97%, or from 60% to 95%, as measured using a solar reflectometer from Surface Optics Corporation (San Diego, CA). For example, in some non-limiting embodiments, the reflective granular composition may exhibit a VIS reflectance of at least 70%, for example, from 70% to 98%, or from 70% to 97%, as measured using a solar reflectometer from Surface Optics Corporation (San Diego, CA).

The reflective granular composition may comprise an effective amount of the kaolin clay and the ATH so as to exhibit an infrared light (“IR”) reflectance (e.g., in the 700-2500 nm wavelength band) of at least 60%, for example from 60% to 98%, or from 60% to 97%, as measured using a solar reflectometer from Surface Optics Corporation (San Diego, CA). For example, in some non-limiting embodiments, the particulate composition may exhibit an IR reflectance of at least 70%, for example, from 70% to 98% or from 70% to 97%, as measured using a solar reflectometer from Surface Optics Corporation (San Diego, CA).

To improve the strength of the resulting reflective granular composition, the particulate mixture may further comprise at least one hardening additive. The hardening additives suitable for use in accordance with the present disclosure may include sodium salts. Exemplary sodium salts that may form the hardening additives may include sodium silicate, sodium hydroxide, or a mixture thereof. In further exemplary embodiments, the sodium salts that may form the hardening additives may include sodium carbonate, sodium chloride, sodium polyacrylate, sodium sulfate, sodium thiosulfate, sodium phosphate, or a mixture thereof. Any of the foregoing salts of barium, potassium, calcium, and lithium may additionally or alternatively be employed, in some non-limiting embodiments. Hydrated forms of any of the foregoing salts are additionally suitable. Sodium (and other) salts of the foregoing varieties may be supplied in either a powder or granular/crystalline form, which may then suitably be mixed into the particulate mixture.

In some non-limiting embodiments, the reflective granular composition may comprise from 1% to 15% by weight of the hardening additive, such as from 1% to 12% by weight, from 1% to 10% by weight, from 1% to 8% by weight, or from 1% to 5% by weight, based on total solids of the reflective granular composition. The reflective granular composition may comprise from 3% to 15% by weight of the hardening additive, such as from 5% to 10% by weight, from 5% to 15% by weight, from 8% to 15% by weight, or from 10% to 15% by weight, based on total solids of the reflective granular composition. The reflective granular composition may comprise from 1 to 3% by weight, from 3% to 5% by weight, from 5% to 7% by weight, from 7% to 10% by weight, from 10% to 12% by weight, or from 12% to 15% by weight, of the hardening additive, based on total solids of the reflective granular composition.

The particulate mixture may be prepared in the form of a slurry for further processing. The slurry may include a liquid media (e.g., water) in addition to at least one binder composition. The slurry may for a substantially homogeneous mixture. As used herein, the term “substantially” is used as a term of approximation, and not as term of degree, and is intended to account for the inherent deviations and variations in measured, observed or calculated properties or values. Accordingly, the term “substantially homogeneous” denotes that the while the mixture may not be perfectly homogeneous, the mixture would be considered homogeneous by those of ordinary skill in the art.

In non-limiting embodiments, a method of forming the slurry may include adding a liquid media (e.g., water) to the mixture of components until a desired consistency is achieved. The desired consistency at this stage of the process may vary depending on a variety of factors, e.g., whether the composition is desired to be ultimately moldable or flowable. In some non-limiting embodiments, however, the liquid media may be added to the particulate mixture in an amount of from 20 to 50% by weight, such as from 30 to 40% by weight, based on total weight of the slurry. For example, in some non-limiting embodiments in which the composition is desired to be moldable, the liquid media may be added to the particulate mixture in an amount of from 20 to 40% by weight, such as from 25 to 35% by weight or from 25 to 30% by weight, based on total weight of the slurry. In some non-limiting embodiments in which the composition is desired to be flowable, the liquid media may be added to the particulate mixture in an amount of from 30 to 50% by weight, such as from 35 to 45% by weight or 35 to 40% by weight, based on total weight of the slurry.

Moreover, in order to improve the consistency and adhesion of the particles within the slurry, a binder material may be added. Suitable binder materials include the class of water-soluble polymers, such as water-soluble synthetic polymers. Water-soluble synthetic polymers may contain hydrophilic functional groups, such as ethers, alcohols, amides, and pyrrolidones. In some non-limiting embodiments or aspects, the binder material may comprise polyvinyl alcohol.

The binder material may be added to the slurry mixture in an amount of from 1 to 10% by weight, such as from 3 to 8% by weight, based on the dry weight of kaolin clay. The binder material may be added to the slurry mixture in an amount of from 1 to 8% by weight, from 1 to 5% by weight, from 3 to 10% by weight, or from 5 to 10% by weight, based on dry weight of kaolin clay. The binder material may be added to the slurry mixture in an amount of from 1 to 3% by weight, from 3 to 5% by weight, from 5 to 8% by weight, or from 8 to 10% by weight, based on dry weight of kaolin clay.

The slurry may then be processed into granule form and/or dried. In some non-limiting embodiments, a method may further include extruding the slurry, or spray granulating the slurry, and drying the extruded or sprayed product. The drying may be performed at any suitable temperature to substantially drive off the liquid media. As discussed above, as used herein, the term “substantially” is a term of approximation, and not a term of degree, and the phrase “substantially drive off the liquid media” is intended to account for inherent deviations in the measurement, calculation or observation of the amount of the liquid media remaining in the mixture after drying. For example, the liquid media would be considered substantially driven off if the amount of liquid media remaining in the mixture is either not detectable or is otherwise negligible, as would be understood by those of ordinary skill in the art.

The temperature for drying the slurry is not particularly limited, and it may vary depending on the liquid media selected. However, the temperature should be high enough to substantially drive off the liquid media, but not high enough to constitute a heat treatment or kilning procedure. For example, drying may be performed at a temperature of from 100° C. to 800° C., such as from 100° C. to 700° C., from 120° C. to 160° C., or from 130° C. to 150° C. Additionally, the time needed to dry the wet mixture is not particularly limited, and it may vary depending on the consistency of the wet mixture, the liquid media used in the wet mixture, the temperature used to perform the drying, and the amount of the liquid media in the wet mixture. In some non-limiting embodiments, drying is performed for from 10 minutes to 90 minutes, such as from 20 minutes to 70 minutes, or from 30 minutes to 60 minutes.

The dried mixture may then be crushed and/or kilned (or subjected to heat treatment). In embodiments in which the dried mixture is both crushed and kilned, the dried mixture may either be crushed first and then kilned, or kilned first, and then crushed. In some non-limiting embodiments, the dried mixture may first be crushed (prior to kilning) to the desired particle size, using a crusher and sieves of the desired size. This pre-crushing may allow any fine materials (or fine particulates) to be re-introduced into the product feed, thereby reducing the amount of waste material generated by the process. The fine particles generated during the crushing process may be recycled by reintroducing them into the production feed. However, because of their smaller particle size, the amount of the liquid media needed to reach the desired consistency of the wet mixture may be increased. In some non-limiting embodiments, the recycled fine particles may be added to the production feed in amount of from 25 wt % of the feed or less.

As discussed above, according to embodiments of the present disclosure, the dried mixture may be kilned either before or after crushing. The kilning process may be performed at any suitable temperature and for any suitable length of time. For example, in some non-limiting embodiments, the dried mixture (either before or after crushing) may be kilned (or fired) at a temperature of from 900° C. to 1500° C., such as from 1000° C. to 1300° C., from 1025° C. to 1275° C., or from 1050° C. to 1250° C.

The resulting granules, in some non-limiting embodiments, may have a bulk density of from 40 lbs/ft³ to 75 lbs/ft³, such as from 50 lbs/ft³ to 75 lbs/ft³, from 40 lbs/ft³ to 60 lbs/ft³, from 50 lbs/ft³ to 60 lbs/ft³, or from 45 lbs/ft³ to 60 lbs/ft³. In some non-limiting embodiments, the resulting granules particulate composition may have a bulk density of from 50 lbs/ft³ to 60 lbs/ft³, such as from 52 lbs/ft³ to 58 lbs/ft³, or from 53 lbs/ft³ to 56 lbs/ft³. The relatively low bulk density of the particulate composition enables significant cost savings. For example, the lower bulk density allows the application of fewer of the particulates (or granules) per unit area (or square) while still achieving the solar reflectance benefits (such as, for example, high total solar reflectance, and/or UV, VIS and/or IR reflectance).

To maintain the high solar reflectance of the granules, the compound should be applied thereto such that the coating and/or surface treatment does not significantly decrease the reflectance of the granules. For example, many suitable coatings and/or surface treatments may be sealants or otherwise clear coatings that do not adversely affect the overall solar reflectance of the granules. In some non-limiting embodiment, the granules may be treated with an emulsion of silanes and siloxanes without added solvents.

The surface treatments and/or coatings can be applied to the granules using a variety of methods and processes known to those of skill in the art. For example, in one exemplary embodiment, after the raw material has been crushed and sized according to the preferred screen size and packaged, the particles can be treated by adding the particles to an aqueous solution fully saturating the particles with the treatment and then, immediately drying the particles to drive off excess moisture at a temperature not exceeding 600° F. (316° C.). In another exemplary embodiment, after the raw material has been crushed and sized according to the preferred screen size and packaged, the particles can be post-treated by spraying the particles with an aqueous solution and then immediately drying the particles to drive off excess moisture at a temperature not to exceed 600° F. (316° C.). In yet another exemplary embodiment, after the raw material has been crushed and sized according to the preferred screen size, the particles can be treated by spraying the particles with an aqueous solution and then immediately kiln drying the particles to drive off excess moisture at a temperature not to exceed 600° F. (316° C.) after which time they can be packaged. In still yet another embodiment of coating and/or treating the surface of granules, after the raw material has been crushed and sized according to the preferred screen size, the particles are treated by spraying with an aqueous solution followed by immediately aerating the particles to drive off excess moisture after which time the particles can be packaged. The coatings and/or surface treatments may be applied as delivered (e.g., off the shelf) or from aqueous dilutions. The dilution ratio may range from 1:5 to 1:200. The dilutions may be prepared from demineralized water.

The reflective granular composition (e.g., untreated or treated) may be used to form an architectural material. The architectural material may comprise a roofing material or other building material. The architectural material may be positioned in an outdoor environment.

The roofing material may be formed by applying the reflective granular composition to an asphalt layer. The asphalt layer may comprise bitumen or modified bitumen, modified with at least one reinforcing material, such as polyester or fiberglass. Such roofing material having the reflective granular composition applied to an asphalt layer may constitute a cool roof system.

### EXAMPLES

The following examples are presented to demonstrate the general principles of the disclosure. The disclosure should not be considered as limited to the specific examples presented. All parts and percentages in the examples are by weight unless otherwise indicated.

### Examples 1-4

### Reflective Granular Composition

For Example 1, a kaolin slurry at 60% slurry concentration in water from KaMin Kaolin (Macon, GA) containing 1000 g of dry kaolin was mixed well in a container. 200 g of 50% concentration sodium silicate solution (N® from PQ Corporation (Malvern, PA)) was added. 333 g of 60% concentration aluminum trihydrate (POLYJET 405) from Cimbar Performance Materials (Chatsworth, GA) was added. The final concentration of kaolin clay was adjusted to 50% by adding water. The slurry was dried overnight at 100° C. The dried mass was kilned in a furnace at 1150° C. for 2 hours to be sintered and then allowed to cool to ambient temperature. The sintered material was crushed through a jaw crusher and sieved to form granules so that the particle sizes were within 8 mesh and 40 mesh. The granules were measured for TSR using Devices and Services Solar Spectrum Reflectometer Model SSR. The TSR of the granules was 89.4, as shown in Table 1. The composition of Example 1 contained 20% by weight ATH and 10% by weight sodium silicate.

The compositions of Examples 2-4 were prepared in the same way as Example 1 but using the amounts of kaolin, ATH, and sodium silicate shown in Table 1. Table 1 shows the TSR for Examples 1-4. Each of the reflective granular compositions of Examples 1-4 exhibited an excellent TSR.

TABLE 1

| Example | Formulation | TSR |
|---|---|---|
| 1 | Kaolin, 20% ATH, 10% Sodium Silicate | 89.40 |
| 2 | Kaolin, 20% ATH, 5% Sodium Silicate | 88.83 |
| 3 | Kaolin, 40% ATH, 5% Sodium Silicate | 90.37 |
| 4 | Kaolin, 40% ATH, 10% Sodium Silicate | 90.13 |

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. A reflective granular composition comprising:
a reflective pigment material comprising kaolin clay;
aluminum trihydrate (ATH); and
a hardening additive.

2. The reflective granular composition of claim 1, wherein the reflective granular composition comprises at least 50% by weight of the kaolin clay, based on total solids of the reflective granular composition.

3. The reflective granular composition of claim 1, wherein the reflective pigment material comprises a secondary pigment component selected from the group consisting of: metal and transition metal oxides, alkaline earth metal sulfates, alkaline earth metal carbonates, transition metal silicates, metal silicates, minerals, and mixtures thereof.

4. The reflective granular composition of claim 1, wherein the reflective pigment material consists of the kaolin clay.

5. The reflective granular composition of claim 1, wherein the reflective granular composition comprises from 5 to 40% by weight of the ATH, based on total solids of the reflective granular composition.

6. The reflective granular composition of claim 1, wherein the hardening additive comprises a sodium salt or another salt.

7. The reflective granular composition of claim 6, wherein the reflective granular composition comprises from 1% to 15% by weight of the sodium salt, based on total solids of the reflective granular composition.

8. The reflective granular composition of claim 6, wherein the reflective granular composition comprises from 3% to 12% by weight of the sodium salt, based on total solids of the reflective granular composition.

9. The reflective granular composition of claim 6, wherein the sodium salt is selected from the group consisting of: sodium silicate, sodium hydroxide, sodium carbonate, sodium chloride, sodium polyacrylate, sodium sulfate, sodium thiosulfate, sodium phosphate, and mixtures thereof; or
wherein the other salt is selected from the group consisting of: any of the foregoing salts of barium, potassium, calcium, and lithium.

10. The reflective granular composition of claim 1 comprising an effective amount of the kaolin clay and the ATH so as to exhibit a total solar reflectance of at least 70%.

11. An architectural material comprising the reflective granular composition of claim 1.

12. The architectural material of claim 11, wherein the architectural material comprises a roofing material.

13. A method for making a reflective granular composition, comprising:
mixing together a reflective pigment material comprising kaolin clay; aluminum trihydrate (ATH); and a hardening additive to form a particulate mixture;
forming a slurry from the particulate mixture by adding to the particulate mixture water and a binder material;
granulating and/or drying the slurry; and
kilning the granulated and/or dried slurry to form the reflective granular composition.

14. The method of claim 13, wherein the reflective pigment material comprises a secondary pigment component selected from the group consisting of: metal and transition metal oxides, alkaline earth metal sulfates, alkaline earth metal carbonates, transition metal silicates, metal silicates, minerals, and mixtures thereof.

15. The method of claim 13, wherein the reflective pigment material consists of the kaolin clay.

16. The method of claim 13, wherein the hardening additive comprises a sodium salt or another salt.

17. The method of claim 16, wherein the sodium salt is selected from the group consisting of: sodium silicate, sodium hydroxide, sodium carbonate, sodium chloride, sodium polyacrylate, sodium sulfate, sodium thiosulfate, sodium phosphate, and mixtures thereof; or
wherein the other salt is selected from the group consisting of: any of the foregoing salts of barium, potassium, calcium, and lithium.

18. The method of claim 13, wherein the water is added in an amount of from 20% to 50% by weight, based on total weight of the slurry.

19. The method of claim 13, wherein the binder material is added in an amount of from 1% to 10% by weight, based on dry weight of kaolin clay.

20. The method of claim 13, wherein granulating the slurry comprises extruding the slurry or spraying the slurry.

21. The method of claim 13, further comprising crushing the dried, granulated slurry prior to kilning the dried, granulated slurry.

22. The method of claim 13, wherein kilning is performed at a temperature of from 900° C. to 1500° C.
